(19) United States
(12) Patent Application Publication
(10) Pub. No.: US 2009/0110165 A1
(43) Pub. Date: Apr. 30, 2009

(54) ARRIVAL CALL STATUS MANAGEMENT SYSTEM, MANAGEMENT DEVICE, MANAGEMENT METHOD AND STORAGE MEDIUM

(75) Inventors: Tooru ABOSHI, Kawasaki (JP); Atsushi SEKIGUCHI, Kawasaki (JP)

Correspondence Address: Fujitsu Patent Center;C/O CPA Global, P.O. Box 52050, Minneapolis, MN, 55402, US

(73) Assignee: FUJITSU LIMITED, Kanagawa (JP)

(21) Appl. No.: 12/249,905

(22) Filed: Oct. 11, 2008

(30) Foreign Application Priority Data
Oct. 26, 2007 (JP) 2007-279654

(51) Int. Cl. H04M 15/00

(52) U.S. Cl. 379/136

(57) ABSTRACT

Prediction information based on past statuses (management information) and past management information and the present management information are comparatively displayed in real time at a call center, thereby enabling arrival call statuses of the whole call center to be easily grasped. A management device connected to an exchange accommodating a plurality of terminal devices used for receiving calls, receives status information showing the call receiving status of each terminal device from the exchange, totalizes pieces of status information of the whole terminal devices and obtaining, as management information, at least one of a total count, an average and a rate with respect to a predetermined status of call, and gets the management information displayed on a display device.

This application claims the benefit of Japanese Patent Application No. 2007-279654 filed on Oct. 26, 2007 in the Japanese Patent Office, the disclosure of which is herein incorporated in its entirety by reference.

### BACKGROUND OF THE INVENTION

The present invention relates a technology of managing an arrival call status at a call center.

In a call center system configured by a private branch exchange, recipient terminals such as multifunction telephones serving as attendant boards, an ACD (Automatic Call Distribution) device and an administrator terminal, the ACD device organizes management information by processing pieces of information about an arrival call, a response, origination of the call and termination of a speech that are supplied from the private branch exchange, and shows an operation status of each individual recipient by getting the management information displayed on the administrator terminal in a seat graphic format and a list format.

Further, the following are technologies disclosed in Patent documents as the prior arts related to the invention of the present application.
[Patent document 1]
Japanese Patent Laid-Open Publication No. 2006-67308
[Patent document 2]

Japanese Patent Laid-Open Publication No. 2003-198736

### SUMMARY OF THE INVENTION

An operation of the conventional call center system is, however, no more than displaying a record of past results of the individual recipients and is not a system that visually displays the status of the whole system in real time, wherein it is difficult to grasp the operation status of the entire call center. The operation at the call center therefore depends largely on [intuition] and [judgment] of the operator, a high-level operation skill and an experience are required of the operator, and there are many restrictions in terms of personnel and staff allocation.

Further, the call center is developed into a multi-base center, the support is highly sophisticated, and support products are increasingly diversified in their categories, and operation of the call center becomes complicated, resulting in having issues of [how much the operation is facilitated] and [how a degree of satisfaction of a customer is balanced with efficiency].

Such being the case, the present system or method aims at providing a technology enabling an arrival call status of the whole call center to be easily grasped.

The present system or method adopts the following configurations in order to solve the problems given above.

Namely, an arrival call status management system according to the present invention comprises:

a plurality of terminal devices accommodated by an exchange and used for receiving calls; and

a management device managing a call receiving status of each of the terminal devices,

the management device including:

a status receiving unit receiving status information showing the call receiving status of each terminal device from the exchange;

a management unit totalizing pieces of status information of the whole terminal devices and obtaining, as management information, at least one of a total count, an average and a rate with respect to a predetermined status of call; and

a display control unit getting the management information displayed on a display device,

each terminal device including:

a reception operating unit operating the call receiving status; and

a speech unit used for speaking about the received call.

The predetermined status of call may be at least one of abort, a response, wait, a first call, a callback, a transfer, origination of a call, a speech when originating a call and a speech when receiving call.

The rate may be at least one of a response rate defined as a rate of a response call count to a total call count, an abort rate defined as a rate of an abort call count to the total call count, an originating number rate defined as a rate of a call count with an originating number notified to the call count excluding the transfer calls, a callback rate defined as a rate of a callback count to the call count with the originating number notified, a within-waiting-time-3-min ratio defined as a ratio of a response call count within 3 min waiting time to the response call count, a within-waiting-time-1-min ratio defined as a ratio of a response call count within 1 min waiting time to the response call count, and productivity defined as a rate of a recipient count to the response call count.

The terminal device may include a status notifying unit notifying the management device of the status information representing a status of at least one of log-in of the recipient who operates the terminal device, a quit-the-seat status, a work other than a speech and log-out, and

the management unit of the management device may obtain based on the status information, as the management information, at least one of an operating rate defined as a rate of the speech time and the work time to the log-in time from the log-in up to the log-out, a reception-enabled rate defined as a rate of the reception-enabled time for which neither the speech nor the quit-the-seat status occurs to the log-in time, and a quit-the-seat rate defined as a rate of the quit-the-seat time to the log-in time.

The management device may include a registration unit registering the management information in the storage unit, and a prediction unit reading the past management information from the storage unit and utilizing the readout information as prediction information, and

the display control unit may notify the display device of the prediction information together with the management information, and may get the management information and the prediction information displayed on the display device.

The management device may further include a workforce calculation unit calculating, when the registration unit of the management device registers the storage unit with the productivity defined as the rate of the number of the recipients who received the calls to the total count of the predetermined statuses of call and with the total count of the predetermined statuses of call, the number of the recipients required for receiving the calls of the prediction information on the basis of the total count of the predetermined statuses of call obtained as the prediction information by the prediction unit and the productivity.

The display control unit may be stored with threshold values preset with respect to respective values of the management information and, if the value of the management information exceeds the threshold value, may change a value display format.

Further, the present management method executed by a management device connected to an exchange accommodating a plurality of terminal devices used for receiving calls, comprises steps of:

receiving status information showing the call receiving status of each terminal device from the exchange;

totalizing pieces of status information of the whole terminal devices and obtaining, as management information, at least one of a total count, an average and a rate with respect to a predetermined status of call; and

getting the management information displayed on a display device.

The predetermined status of call may be at least one of abort, a response, wait, a first call, a callback, a transfer, origination of a call, origination of a call, a speech when originating a call and a speech when receiving call.

In the management method, the rate may be at least one of a response rate defined as a rate of a response call count to a total call count, an abort rate defined as a rate of an abort call count to the total call count, an originating number rate defined as a rate of a call count with an originating number notified to the call count excluding the transfer calls, a callback rate defined as a rate of a callback count to the call count with the originating number notified, a within-waiting-time-3-min ratio defined as a ratio of a response call count within 3 min waiting time to the response call count, a within-waiting-time-1-min ratio defined as a ratio of a response call count within 1 min waiting time to the response call count, and productivity defined as a rate of a recipient count to the response call count.

In the management method, the terminal device may notify the management device of the status information representing a status of at least one of log-in of the recipient who operates the terminal device, a quit-the-seat status, a work other than a speech and log-out; and

may further comprise a step of obtaining based on the status information, as the management information, at least one of an operating rate defined as a rate of the speech time and the work time to the log-in time from the log-in up to the log-out, a reception-enabled rate defined as a rate of the reception-enabled time for which neither the speech nor the quit-the-seat status occurs to the log-in time, and a quit-the-seat rate defined as a rate of the quit-the-seat time to the log-in time.

The management method may further comprise steps of: registering the management information in the storage unit; and reading the past management information from the storage unit and utilizing the readout information as prediction information,

notifying the display device of the prediction information together with the management information, wherein the display device may obtain the management information and the prediction information, thereby to display them on the display device.

The management method may further comprise a step of calculating, when the productivity defined as the rate of the number of the recipients who received the calls to the total count of the predetermined statuses of call and with the total count of the predetermined statuses of call are registered in the storage module, the number of the recipients required for receiving the calls of the prediction information on the basis of the total count of the predetermined statuses of call obtained as the prediction information and the productivity.

In the management method, threshold values preset with respect to respective values of the management information may be stored and, if the value of the management information exceeds the threshold value, a value display format may be changed.

Further, the present invention may also be a management program for making a computer execute the management method. Still further, the present invention may also be a readable-by-computer recording medium recorded with the management program. The computer is made to read and execute the program on the recording medium, whereby the functions thereof can be provided.

Herein, the readable-by-computer recording medium connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc are given as the recording mediums fixed within the computer.

According to the present invention, it is feasible to provide the technology enabling the arrival call status of the whole call center to be easily grasped.

### BRIEF DESCRIPTION OF THE DRAWINGS

FIG. 1 is a diagram of architecture of an arrival call status management system.

FIG. 2 is a schematic diagram of a reception terminal.

FIG. 3 is a diagram showing one example of the reception terminal.

FIG. 4 is a schematic diagram of a configuration of a management device.

FIG. 5 is an explanatory diagram of a management method in the arrival call status management system.

FIG. 6 is a diagram showing a display example of a response status.

FIG. 7 is a diagram showing a display example of the response status.

FIG. 8 is a diagram showing a display example of the response status.

FIG. 9 is a diagram showing a display example of the response status.

FIG. 10 is a diagram showing a display example of a work force status.

FIG. 11 is a diagram showing a display example of the work force status.

FIG. 12 is a diagram showing a display example of a necessary work force count.

FIG. 13 is a diagram showing a graph of a total call count.

FIG. 14 is a diagram showing a correlation between respective items of management information.

### DETAILED DESCRIPTION OF THE INVENTION

A best mode for carrying out the present invention will hereinafter be described with reference to the drawings. A configuration in the following embodiment is an exemplification, and the present invention is not limited to the configuration in the embodiment.

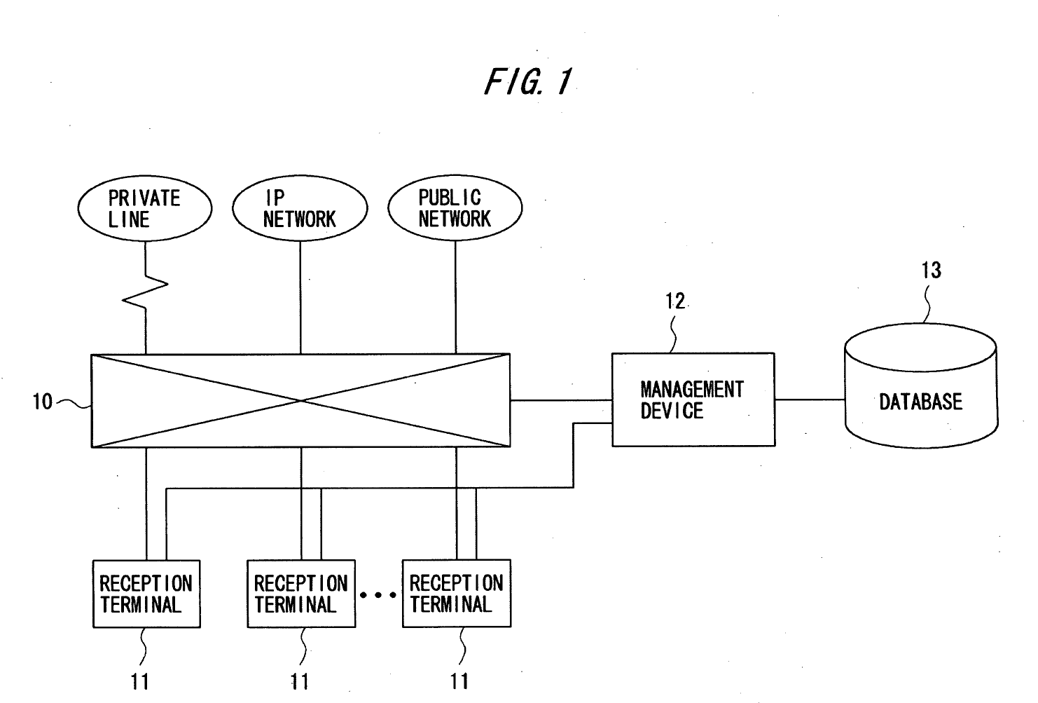

FIG. 1 is an explanatory diagram of an architecture of an arrival call status management system at a call center. The arrival call status management system 1 in the present embodiment includes a private branch exchange 10 accommodating a plurality of lines such as a public network, an IP network and a private line (which will hereinafter be also simply termed lines), a plurality of reception terminals (terminal devices) 11 accommodated by the private branch exchange 10, a management device 12 having a CTI (Computer Telephone Interface) server mechanism and an ACD (Automatic Call Distribution) mechanism, and a database server 13.

The management device 12 is connected via a network to the private branch exchange 10, the reception terminal 11 and the database server 13, and the reception terminal 11 is connected via the network to the private branch exchange 10 and the management device 12.

The private branch exchange 10 permits, based on the ACD of the management device 12, the reception terminal 11 to receive an incoming call from the line side, and controls call origination from the reception terminal 11 to the line side. Further, the private branch exchange 10 notifies, for every call, the management device 12 of status information showing a predetermined status such as a standby status, abort (disconnection on the call originating side before a response), a response, a transfer and termination (termination of the response).

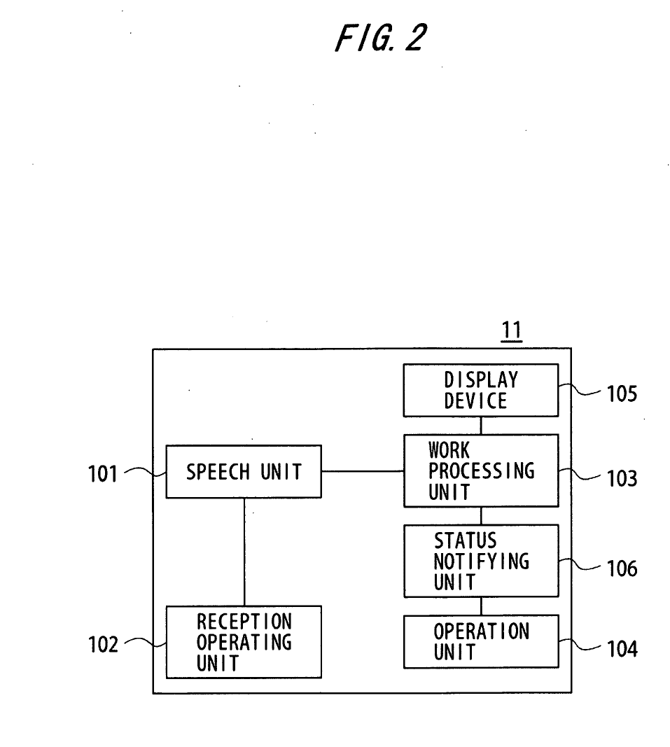

The reception terminal 11 includes, as illustrated in FIG. 2, a speech unit 101, a reception operating unit 102, a work processing unit 103, an operation unit 104, a display unit 105 and a status notifying unit 106.

The speech unit 101 is used for a speech answering the received call, and includes a headset (an ear receiver) constructed of a speaker which outputs a voice and a microphone which converts the recipient voice into an electric signal, a decoding unit that modulates, amplifies and decodes the voice signal received from the private branch exchange 10 and outputs the decoded voice signal to the speaker, and an encoding unit that modulates or encodes the voice signal output from the microphone and transmits the modulated or encoded voice signal to the private branch exchange 10.

The reception operating unit 102 is operated by the call recipient and changes the call status such as the call arrival (a start of speech), a call disconnection, the call termination and the call transfer. For example, when the call recipient performs an incoming call operation such as lifting the ear receiver or pressing an incoming call button, the reception operating unit 102 closes the circuit by connecting the line to the ear receiver or the headset, and starts answering, i.e., sets the reception terminal 11 in a speech status. When the call recipient presses a transfer destination button, the private branch exchange 10 is notified of a signal specifying the transfer destination. When the call recipient puts the ear receiver down or presses a ring-off button, the speech is finished by opening the circuit.

The work processing unit 103 executes processes other than the speech related to the received case, such as creating a document, inputting to a database, ordering parts and making arrangement for a repair.

The operating unit 104 is defined as a means such as a so-called keyboard and a pointing device for inputting to the work processing unit 103 and the status notifying unit 106 by an operation of the call recipient.

The display unit 105 displays input information to the work processing unit 103, a result of processing by the work processing unit 103 and a status such as a quit-the-seat status and an on-the-work status.

The status notifying unit 106 notifies the management device 12 of pieces of status information showing the status (state) such as log-in, the quit-the-seat status, a work other than the speech and log-out by the operation of the call recipient.

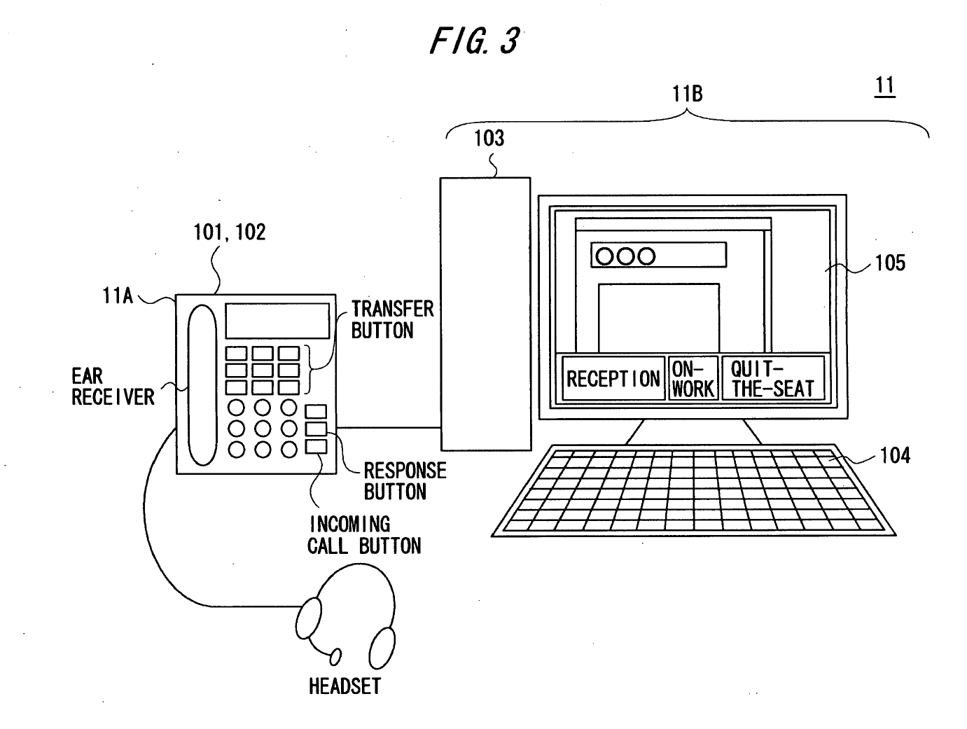

Note that it may be sufficient for the reception terminal 11 to include at least the speech unit 101 and the reception operating unit 102, and the reception terminal 11 may also be, e.g., an extension telephone. Further, the reception terminal 11 may be constructed of, as illustrated in FIG. 3, a plurality of devices such as a telephone 11A including the speech unit 101 and the reception operating unit 102, and a computer 11B including the work operation unit 104 and the display unit 105.

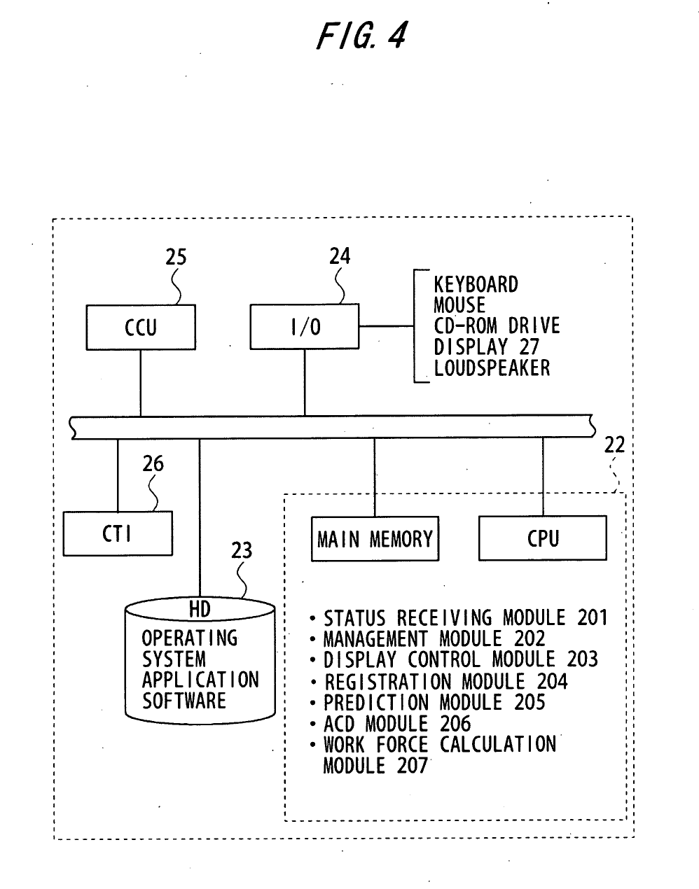

FIG. 4 is a schematic block diagram of the management device 12 in the embodiment. As shown in FIG. 4, the management device 12 is a computer including, within its body, an arithmetic processing unit 22 constructed of a CPU (Central Processing Unit), a main memory, etc, a storage unit (hard disc) 23 stored with data and software for the arithmetic process, an input/output port 24, a communication control unit (CCU) 25, a CTI (Computer Telephone Interface) unit 26, etc.

The Input devices such as the keyboard and the pointing device )operating unit) and a CD-ROM drive and the output devices such as a display device 27 and a printer, are properly connected to the I/O port 24.

The CCU 15 controls communications with other computers via the network.

The CTI unit 26, which connects to the private branch exchange 10, receives the information of the reception terminal 11 and the call information, and transmits the information on the control of the reception terminal 11 and on the call control.

The storage unit 23 is preinstalled with an operating system (OS) and application software (a management program).

The arithmetic processing unit 22 properly reads the OS and the application program from the storage unit 23, then executes the OS and the application program, and arithmetically processes the information inputted from the I/O port 14 and the CCU 15 and the information read from the storage unit 23, thereby functioning as a status receiving unit 201, a management unit 202, a display control unit 203, a registration unit 204, a prediction unit 205, an ACD unit 206 and a work force calculation unit 207.

The status receiving unit 201 receives the status information showing a call receiving status of each reception terminal 11 via the CTI unit 26 from the private branch exchange 10.

The management unit 202 totalizes pieces of status information on all of the reception terminals 11 and obtains, as the management information, at least one of a total count, an average and a rate about the predetermined status of call.

The display control unit 203 gets the management information displayed on the display device 27. At this time, the display control unit 203 displays the call status received by the reception terminal 11 in real time as compared with a record of the past results (the management information) and a prediction based on the past results. Further, the display control unit 203 gets the work force count needed for the predicted reception displayed on the display device 27.

The registration unit 204 registers the management information in the database server (storage unit) 13.

The prediction unit 205 reads the past management information with a predetermined extraction condition from the database server 13, and sets prediction information in a way that multiplies the management information by a predetermined coefficient.

The ACD unit 206 notifies the private branch exchange 10 of control information so as to evenly distribute the calls to the reception terminals 11 in a reception-enabled status on the basis of the management information given from the private branch exchange 10 and the status given from the reception terminal 11.

The work force calculation unit 207 calculates the number of recipients needed corresponding to the call status predetermined by the prediction unit.

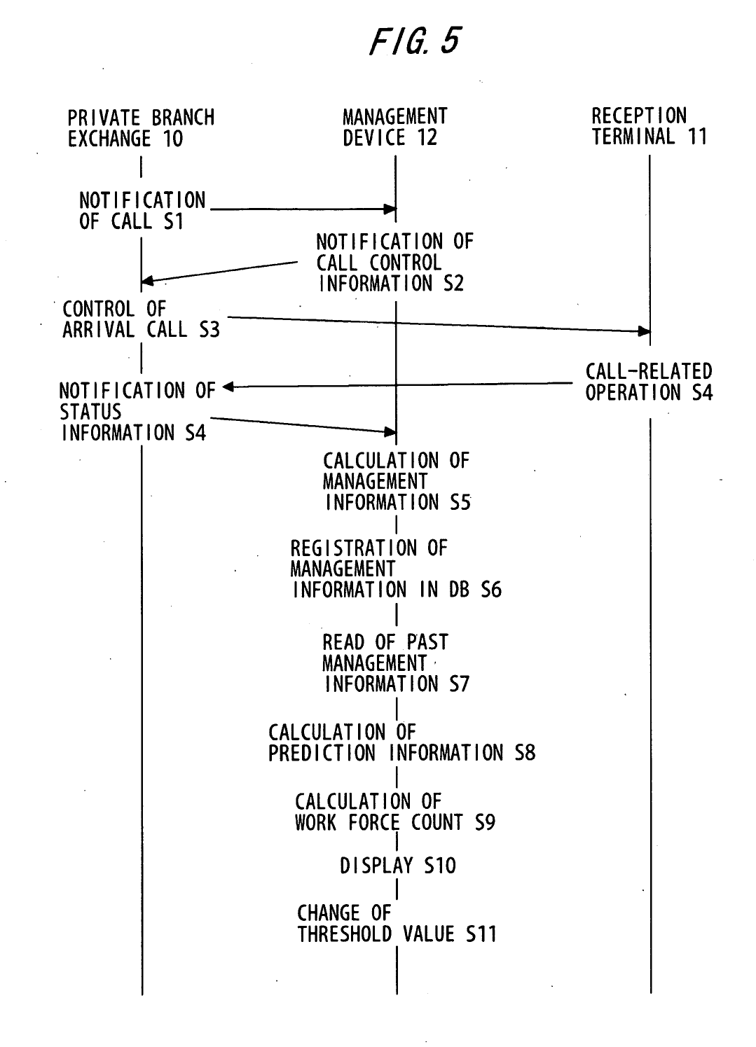

FIG. 5 is an explanatory diagram showing a management method in the arrival call status management system having the configuration given above.

To begin with, the private branch exchange 10, when receiving a call connection request from the line side, notifies the management device 12 of this request (step 1, which will hereinafter also be abbreviated such as S1).

The management device 12 receiving the connection request notifies the private branch exchange 10 of the control information so that the ACD unit 206 distributes the call to the reception terminal 11 in the reception-enabled status (S2). Note that if there is no reception terminal 11 in the reception-enabled status, the management device 12 sets the system in the standby status till the reception terminal 11 in the reception-enabled status comes out.

The private branch exchange 10 gets the call received by the reception terminal 11 specified by the control information (S3).

When the reception terminal 11 performs the operation for the call such as answering to the call, transferring the call and terminating the speech, the private branch exchange 10 detects this status and notifies the management device 12 of this detected status as the status information (S4).

In the management device 12 receiving the status information, the management unit totalizes the pieces of status information on the whole terminal devices and obtains, as the management information, at least one of the total count, the average and the rate (S5).

Further, the registration unit of the management device 12 registers the management information in the database server 13 (S6).

The prediction unit of the management device 12 reads, based on the predetermined extraction condition, the past management information from the database server (S7). For example, if a day of the week is the same, there must be a strong tendency having a similar call request, and therefore the prediction unit extracts the management information of the same day of the previous week and the management information of the same day of the two weeks before.

Then, the prediction unit organizes the call prediction information utilized thereafter in a way that executes a predetermined process about the extracted past management information (S8). For example, the prediction unit obtains the average, at an interval of a predetermined period, of the management information (the past management information) of the same day of the previous week and the management information of the same day of the two weeks before. Moreover, the prediction unit previously sets correlation coefficients corresponding to external factors exemplified by announcement of a new product, time factors such as the Christmas season and a long-term vacation, and weather factors such as a typhoon and the falling of a thunderbolt, and multiplies the past management information by the correlation coefficient. To be specific, the correlation coefficients are a value that is 1.5 times the total count based on the past management information on the day when the new product is announced, a value that is 1.1 times the total count of the calls related to electrical products on the day when the falling of the thunderbolt occurs, a value that is 0.9 times on the days when an election and the World Series of the sports are held, and so on. Further, if there occurs a difference between the predicted value and the actual value, a value of the period thereafter is corrected based on this difference. For example, if a value in the morning is larger by 10% than the predicted value, the predicted value in the afternoon is increased by 10%.

Moreover, the work force calculation unit 207 calculates a total count of the predetermined statuses of call obtained as the prediction information by the prediction unit and the number of the call recipients needed for receiving the calls of the prediction information based on the productivity (S9).

The display control unit 203 of the management device 12 displays the present management information in comparison with the past management information and the prediction information. Further, the display control unit 203 displays the number of the call recipients necessary for receiving the calls of the prediction information (S10). At this time, the display control unit 203 may display items selected by an administrator.

Further, the display control unit 203 is stored with threshold values preset with respect to the respective values of the management information, and changes a value display format if the value of the management information exceeds the threshold value. For example, if the difference between the value of the present management information and the value of the prediction information exceeds the threshold value, if the difference between the number of the call recipients needed for receiving the calls of the prediction information and a scheduled number (a plan value) of the call recipients exceeds the threshold value, if an abort call count and an average period of waiting time exceed the threshold values, and if a within-waiting-time-3-min ratio and a within-waiting-time-1-min ratio are less than the threshold values (these ratios decrease under the threshold values), a background color changes from white to red. Further, an available scheme is that a plurality of threshold values is set, and the background color changes to yellow if over a first threshold value and further changes to red if further over a second threshold value. Note that the change of the display format is not limited to the color change but may include flickering and inverting. Moreover, if over the threshold value, an alarm unit for outputting an alarm sound and sending an electronic mail to a predetermine address may also be provided as well as changing the display format if over the threshold value.

Further, when the administrator inputs a desired threshold value from on the operating unit such as the keyboard and the pointing device, the management device 12 changes the threshold value (S11).

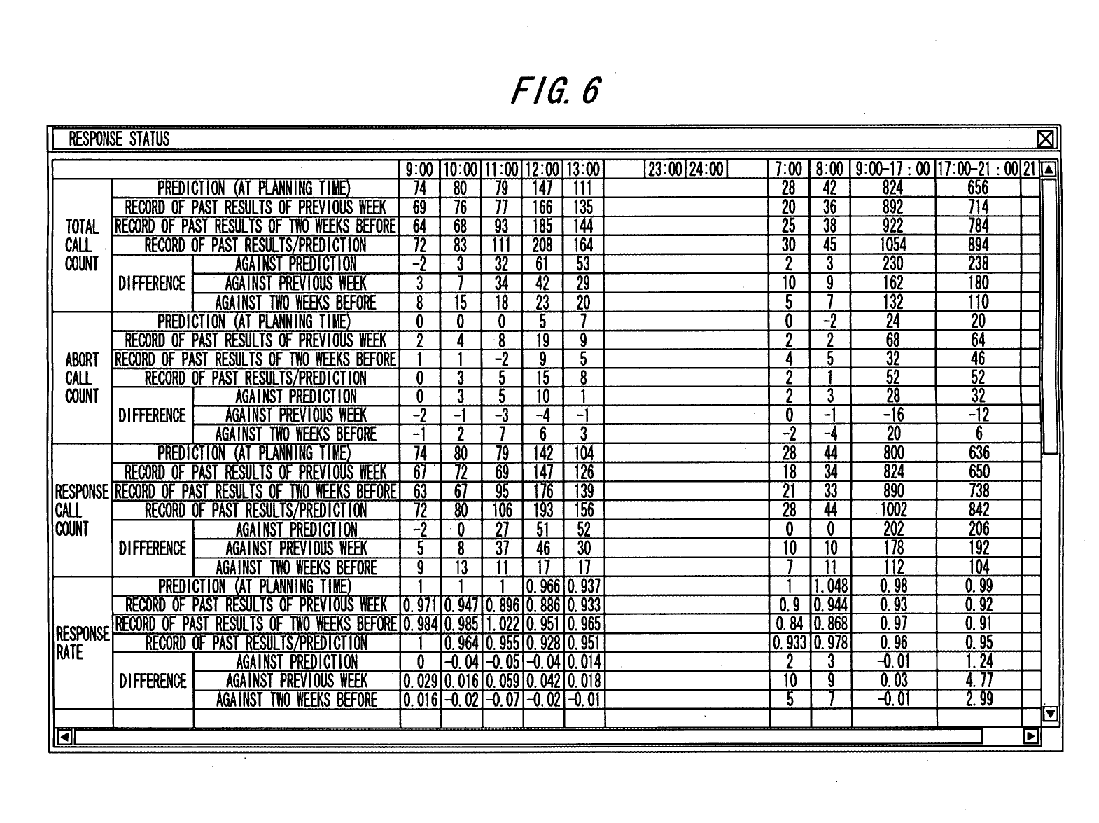

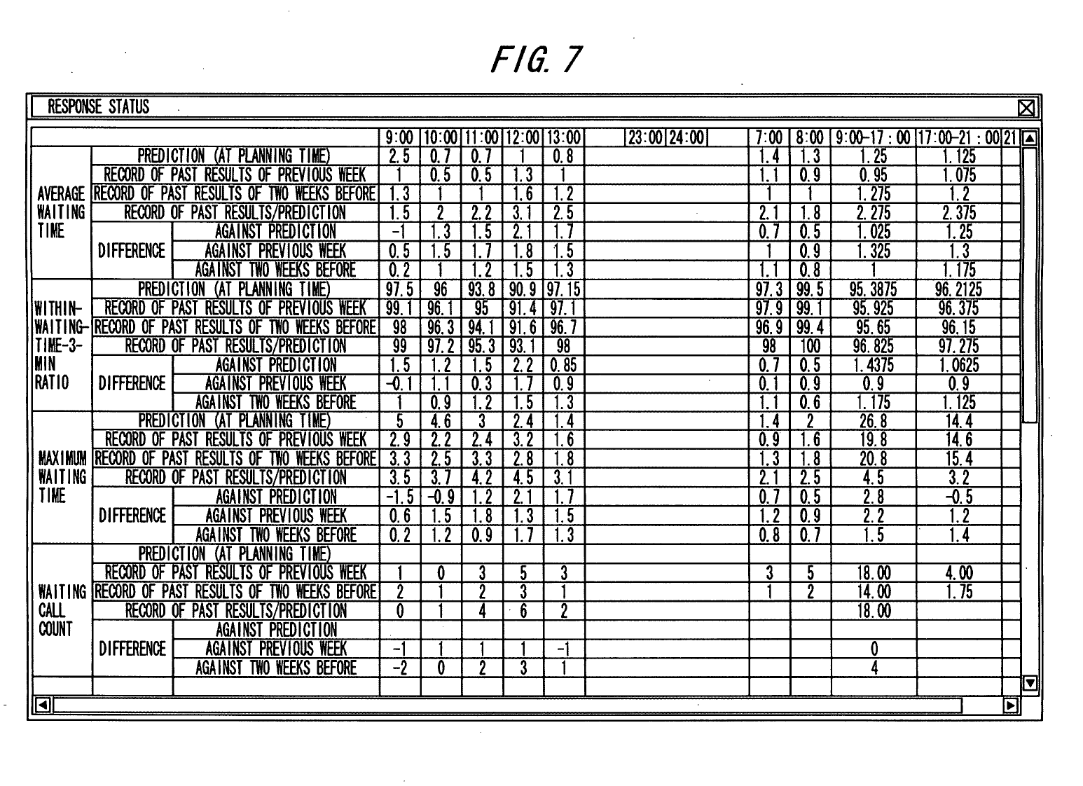

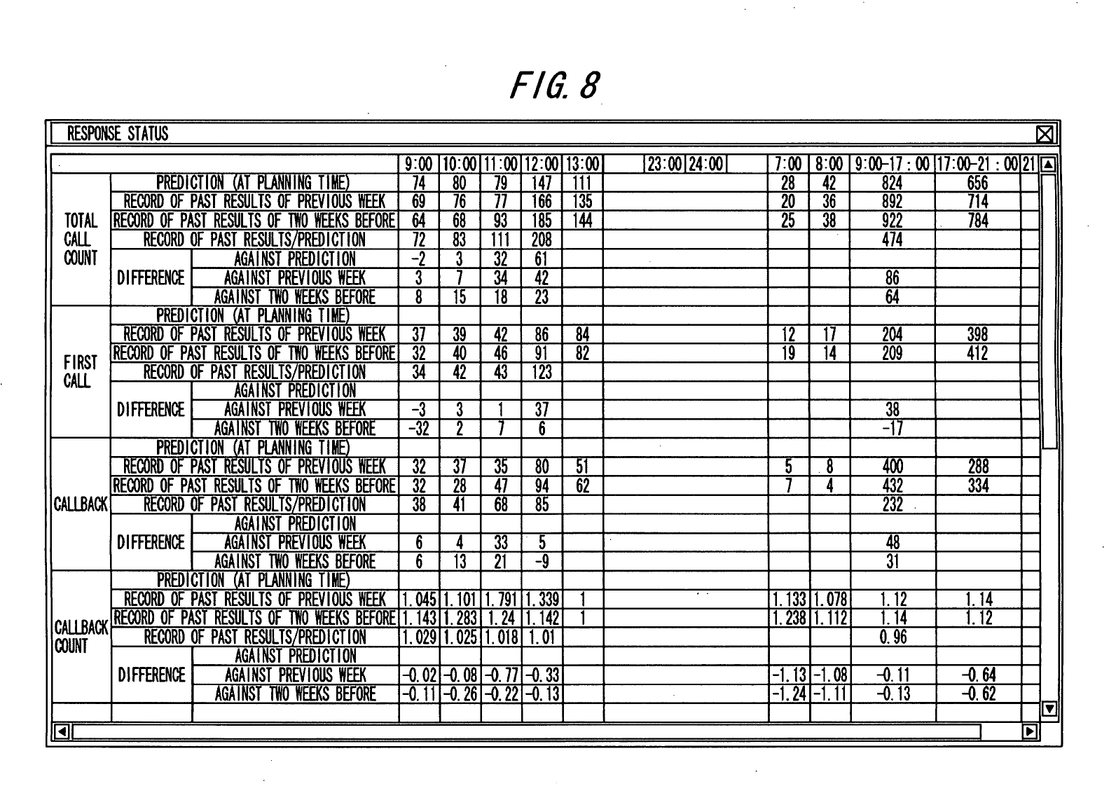

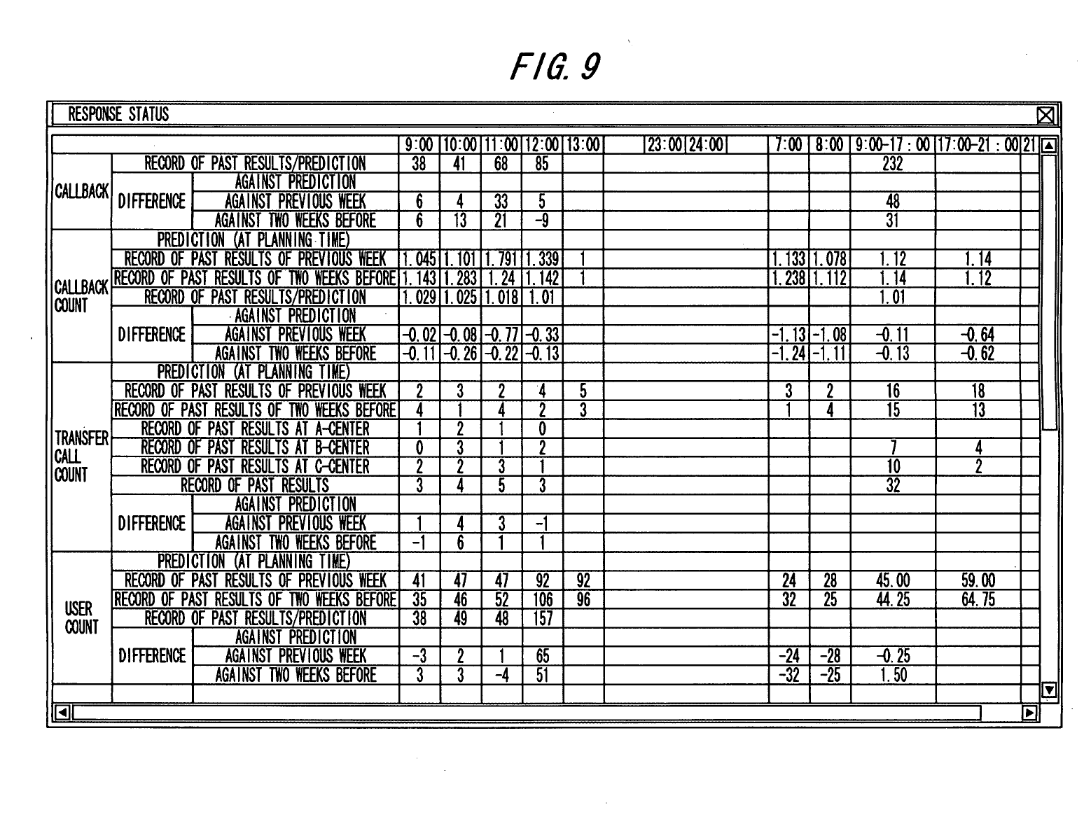

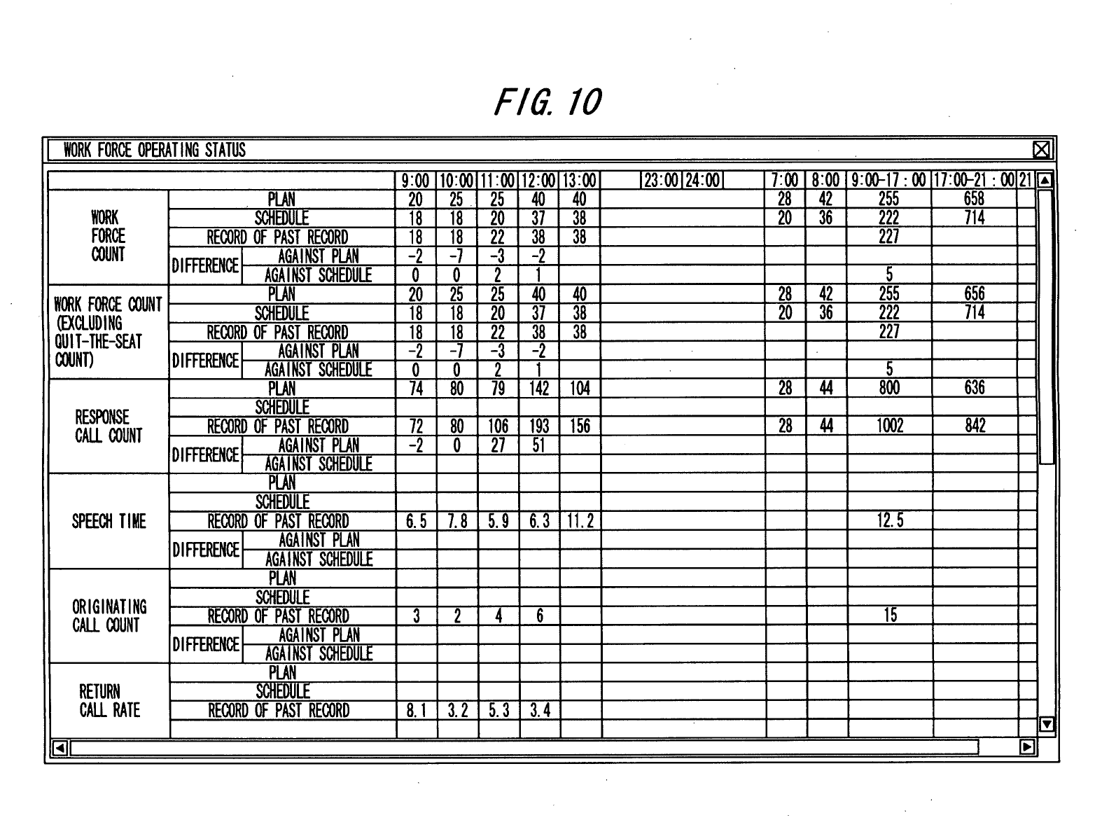

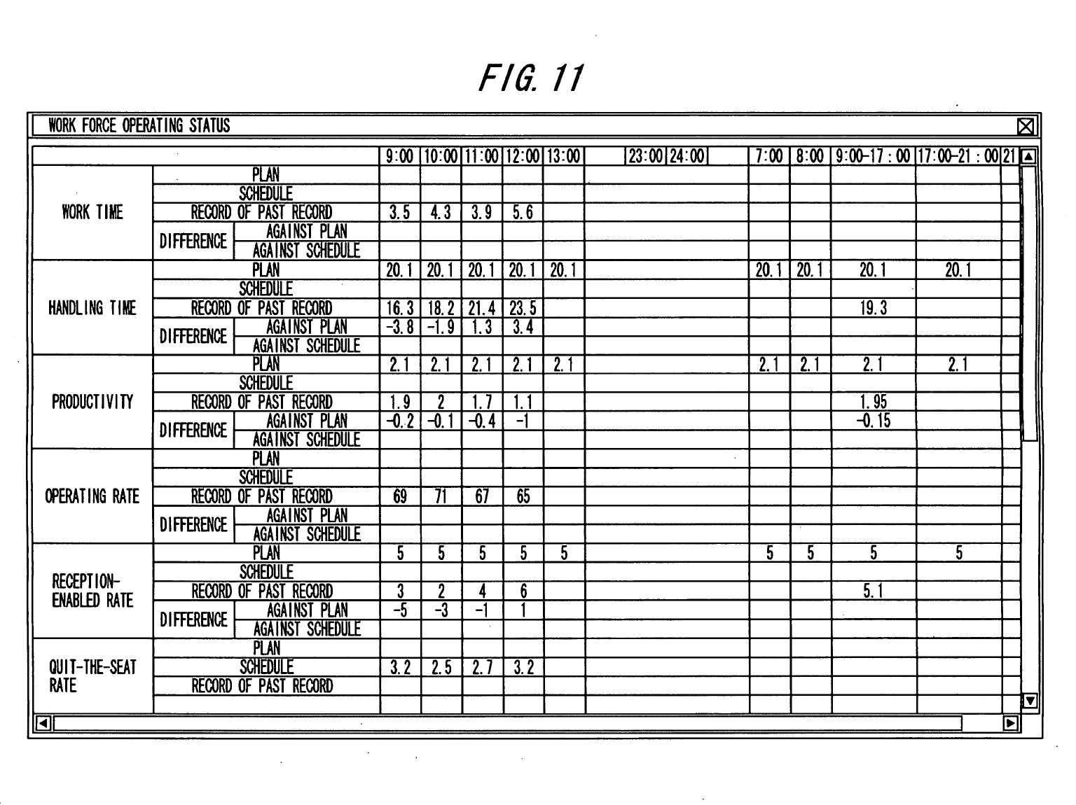

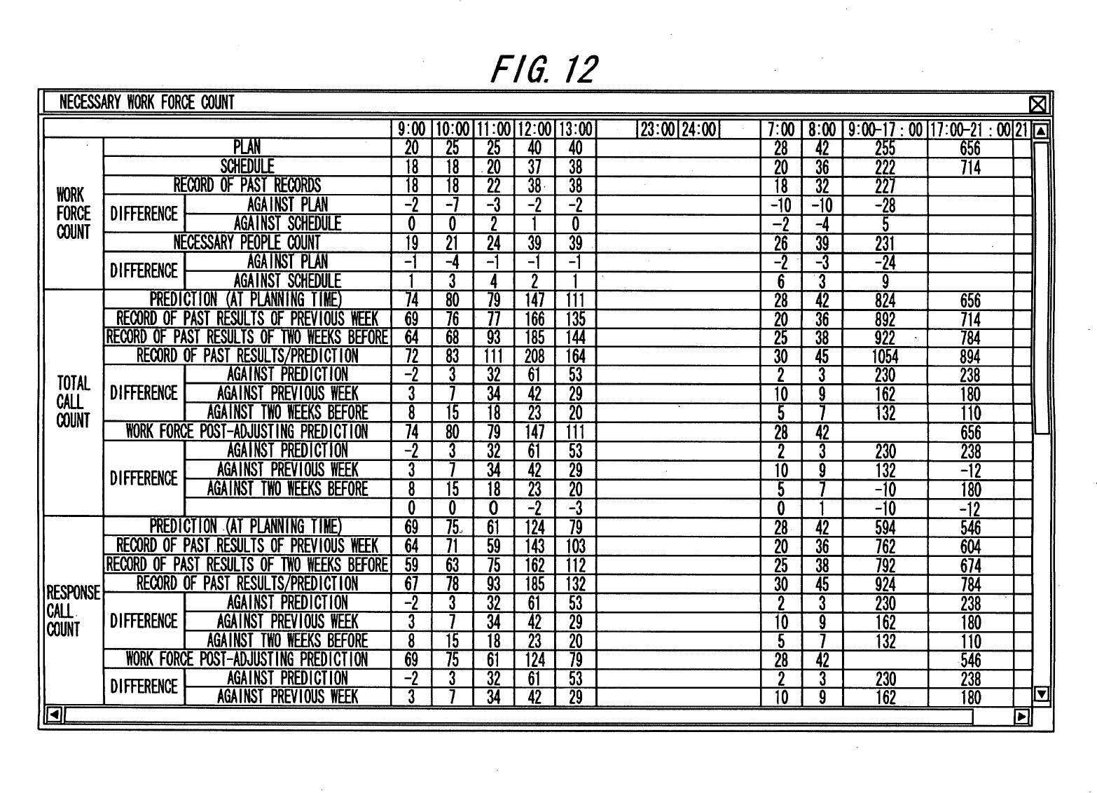

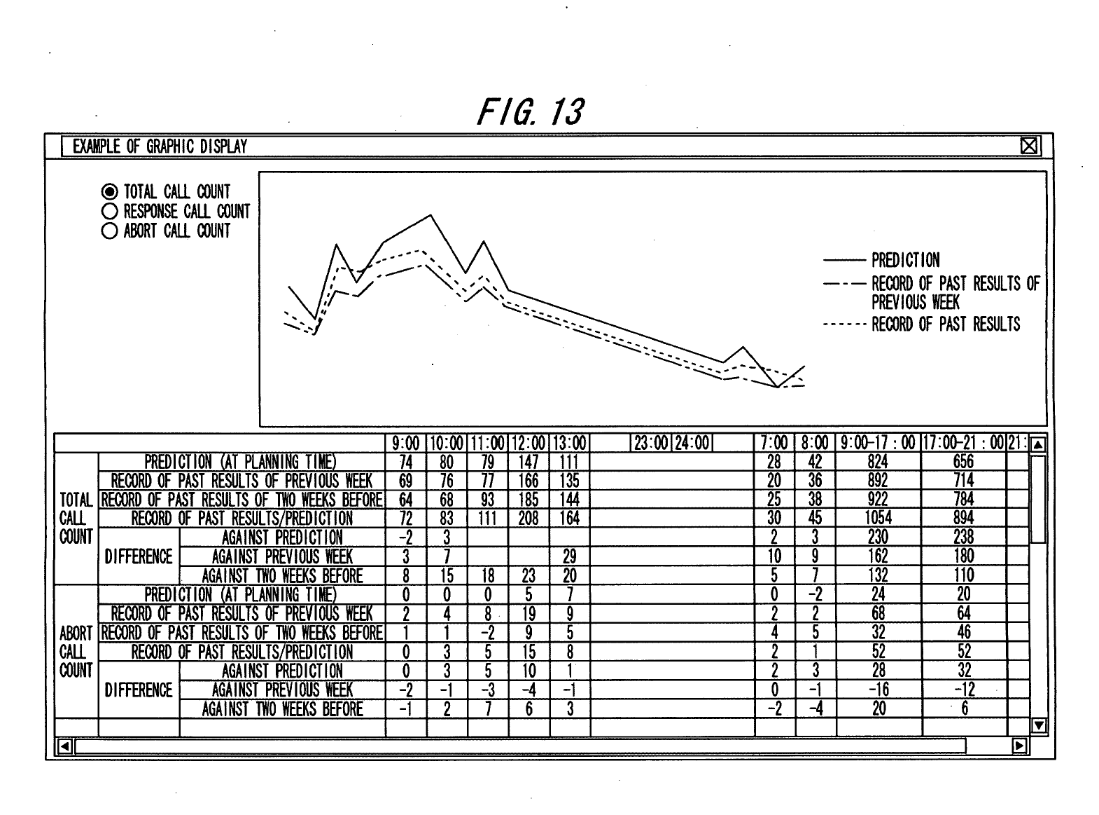

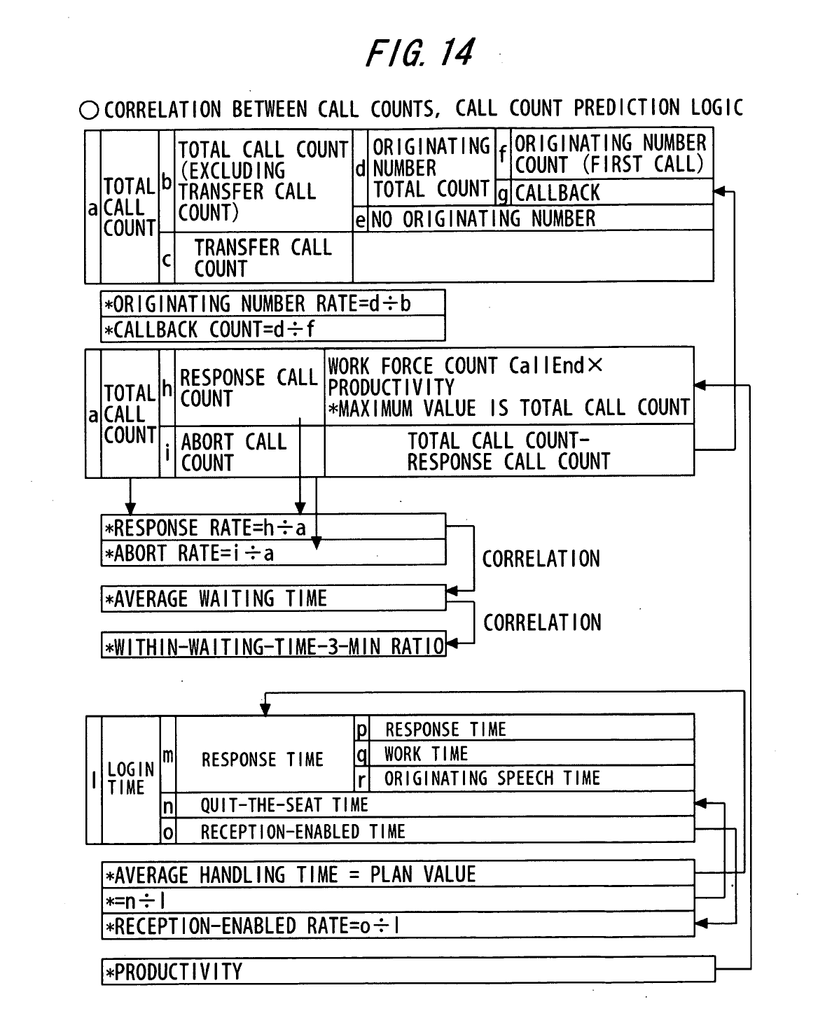

FIGS. 6 and 7 are diagrams each showing a display example of the response status, FIGS. 8 and 9 are diagrams each showing a display example of the arrival call status, FIGS. 10 and 11 are diagrams each showing a display example of the work force status, FIG. 12 is a diagram showing a display example of the necessary work force count, FIG. 13 is a diagram displaying a total call count in graph, and FIG. 14 is a diagram showing correlations between the respective items.

In FIGS. 6-12, a half-tone meshing area represents an item in which the color changes when over the threshold value.

Further, in FIGS. 6-14, the respective items are defined as follows.

A total call count (a): This is a total count of the arrival calls, and represents a transfer call count (c) transferred from within the call center and an arrival call count (b) other than the call count (c).

An originating number total count (d): This is the number of calls with an originator's number (telephone number) notified in the call count (b).

A non-originating number count (e): This is the number of calls with the originator's number (telephone number) not notified in the call count (b).

A first call/originating number count (f): This is a first call count in the calls with the originator's number (telephone number) notified.

A callback count (g): This is an other-than-the-first call count, i.e., a callback count from the same user in the calls with the originator's number (telephone number) notified.

An originating number rate: This is given by (d)÷(b).

A callback count: This is given by (d)÷(f).

A response call count (h): This is a response call count in the total call count (a).

An abort call count (i): This is an answer-disabled call count and given by (a)−(h).

An answering rate: This is given by (h)÷(a), which is a rate of the response call count to the total call count.

An abort rate: This is given by (i)÷(f), which is a rate of the abort call count to the total call count.

Average waiting time: This is an average period of the waiting time till answered since the private branch exchange 10 has received the call request in the answered calls.

A within-waiting-time-3-min ratio: This is a ratio of the call count of which the waiting time is within 3 min to the response call count.

A within-waiting-time-1-min ratio: This is a ratio of the call count of which the waiting time is within 1 min to the response call count.

A work force count: This is the number of the recipients.

Log-in time (l): This is a period of time for which the recipient logs in the private branch exchange 10 or the management device 12 by use of the reception terminal 11 and given by (m)+(n)+(o).

Response time (m): This is a period of time expended for one call and given by (p)+(q)+(r).

Speech time (p): This is a period of time till the call is terminated since a response to the arrival call has been started.

Work time (q): This is a period of time taken for a work such as creating a document required for responding to the arrival call and inputting to the database.

Originating speech time (r): This is a period of time for which the recipient originates the call to the user (to the line side) and speeches on the phone.

Originating call count: This is a call count with which the recipient originates the call to the user (to the line side).

Quit-the-seat time (n): This is a period of time for which the status has been changed to the “quit-the-seat” status by operating the reception terminal when the recipient quits the seat.

Reception-enabled time (0): This is a free period of time, i.e., a new period of reception-enabled time other than the response time (m) and the quit-the-seat time (n).

A quit-the-seat rate: This is given by (n)÷(l).

A reception-enabled rate: This is given by (o)÷(l).

Productivity: This is a rate of the number of the recipients who receives the calls to the total count (the response count in this example) of the predetermined status of call.

A return call rate: This is a rate of the response call count (h) to the originating call count.

An operating rate: This is a rate of the quit-the-seat time and the reception-enabled time to the log-in time.

A reception-enabled rate: This is a rate of the reception-enabled time to the login time.

As described above, according to the present embodiment, the record of the past results received by each reception terminal 11 is registered as the management information in the database server 13 on a knowledge basis, whereby the prediction information based on the past statuses (the management information) and the past management information can be displayed in real time in comparison with the present management information.

Namely, it is feasible to easily determine whether there exists a divergence between the present status, the past management information and the prediction information or not by comparing these items of information with each other.

Accordingly, this scheme enables an inexperienced administrator having none of a high-level operation skill to handle the system so that the administrator can easily grasp the statuses of the arrival calls at the whole call center, thereby relaxing the restriction about the workers in terms their skills.

The invention is not limited to only the illustrated examples given above but can be, as a matter of course, changed in a variety of forms within the scope that does not deviate from the gist of the present invention.

What is claimed is:

1. An arrival call status management system comprising:
a plurality of terminal devices accommodated by an exchange and used for receiving calls; and
a management device managing a call receiving status of each of the terminal devices,
the management device including:
a status receiving unit receiving status information showing the call receiving status of each terminal device from the exchange;
a management unit totalizing pieces of status information of the whole terminal devices and obtaining, as management information, at least one of a total count, an average and a rate with respect to a predetermined status of call; and
a display control unit getting the management information displayed on a display device,
each terminal device including:
a reception operating unit operating the call receiving status; and
a speech unit used for speaking about the received call.

2. The arrival call status management system according to claim 1, wherein the predetermined status of call is at least one of abort, a response, wait, a first call, a callback, a transfer, origination of a call, origination of a return call, a speech when originating a call and a speech when receiving call.

3. The arrival call status management system according to claim 1, wherein the rate is at least one of a response rate defined as a rate of a response call count to a total call count, an abort rate defined as a rate of an abort call count to the total call count, an originating number rate defined as a rate of a call count with an originating number notified to the call count excluding the transfer calls, a callback rate defined as a rate of a callback count to the call count with the originating number notified, a within-waiting-time-3-min ratio defined as a ratio of a response call count within 3 min waiting time to the response call count, a within-waiting-time-1-min ratio defined as a ratio of a response call count within 1 min waiting time to the response call count, and productivity defined as a rate of a recipient count to the response call count.

4. The arrival call status management system according to claim 1, wherein the terminal device includes a status notifying unit notifying the management device of the status information representing a status of at least one of log-in of the recipient who operates the terminal device, a quit-the-seat status, a work other than a speech and log-out, and the management unit of the management device obtains based on the status information, as the management information, at least one of an operating rate defined as a rate of the speech time and the work time to the log-in time from the log-in up to the log-out, a reception-enabled rate defined as a rate of the reception-enabled time for which neither the speech nor the quit-the-seat status occurs to the log-in time, and a quit-the-seat rate defined as a rate of the quit-the-seat time to the log-in time.

5. The arrival call status management system according to claim 1, wherein the management device includes a registration unit registering the management information in the storage unit, and a prediction unit reading the past management information from the storage unit and utilizing the readout information as prediction information, and
the display control unit notifies the display device of the prediction information together with the management information, and gets the management information and the prediction information displayed on the display device.

6. The arrival call status management system according to claim 5, wherein the management device further includes a workforce calculation unit calculating, when the registration unit of the management device registers the storage unit with the productivity defined as the rate of the number of the recipients who received the calls to the total count of the predetermined statuses of call and with the total count of the predetermined statuses of call, the number of the recipients required for receiving the calls of the prediction information on the basis of the total count of the predetermined statuses of call obtained as the prediction information by the prediction unit and the productivity.

7. The arrival call status management system according to claim 1, wherein the display control unit is stored with threshold values preset with respect to respective values of the management information and, if the value of the management information exceeds the threshold value, changes a value display format.

8. A management device connected to an exchange accommodating a plurality of terminal devices used for receiving calls, comprising:
a status receiving unit receiving status information showing the call receiving status of each terminal device from the exchange;
a management unit totalizing pieces of status information of the whole terminal devices and obtaining, as management information, at least one of a total count, an average and a rate with respect to a predetermined status of call; and
a display control unit getting the management information displayed on a display device.

9. The management device according to claim 8, wherein the predetermined status of call is at least one of abort, a response, wait, a first call, a callback, a transfer, origination of a call, origination of a call, a speech when originating a call and a speech when receiving call.

10. The management device according to claim 8, wherein the rate is at least one of a response rate defined as a rate of a response call count to a total call count, an abort rate defined as a rate of an abort call count to the total call count, an originating number rate defined as a rate of a call count with an originating number notified to the call count excluding the transfer calls, a callback rate defined as a rate of a callback count to the call count with the originating number notified, a within-waiting-time-3-min ratio defined as a ratio of a response call count within 3 min waiting time to the response call count, a within-waiting-time-1-min ratio defined as a ratio of a response call count within 1 min waiting time to the response call count, and productivity defined as a rate of a recipient count to the response call count.

11. The management device according to claim 8, wherein the terminal device comprising a status notifying unit notifying the management device of the status information representing a status of at least one of log-in of the recipient who operates the terminal device, a quit-the-seat status, a work other than a speech and log-out, and
the management unit obtains based on the status information, as the management information, at least one of an operating rate defined as a rate of the speech time and the work time to the log-in time from the log-in up to the log-out, a reception-enabled rate defined as a rate of the reception-enabled time for which neither the speech nor the quit-the-seat status occurs to the log-in time, and a quit-the-seat rate defined as a rate of the quit-the-seat time to the log-in time.

12. The management device according to claim 8, further comprising:
a registration unit registering the management information in the storage unit; and
a prediction unit reading the past management information from the storage unit and utilizing the readout information as prediction information,
wherein the display control unit notifies the display device of the prediction information together with the management information, and gets the management information and the prediction information displayed on the display device.

13. The management device according to claim 12, further comprising a workforce calculation unit calculating, when the registration unit of the management device registers the storage unit with the productivity defined as the rate of the number of the recipients who received the calls to the total count of the predetermined statuses of call and with the total count of the predetermined statuses of call, the number of the recipients required for receiving the calls of the prediction information on the basis of the total count of the predetermined statuses of call obtained as the prediction information by the prediction unit and the productivity.

14. The management device according to claim 8, wherein the display control unit is stored with threshold values preset with respect to respective values of the management information and, if the value of the management information exceeds the threshold value, changes a value display format.

15. A management method executed by a management device connected to an exchange accommodating a plurality of terminal devices used for receiving calls, the method comprising steps of:
receiving status information showing the call receiving status of each terminal device from the exchange;
totalizing pieces of status information of the whole terminal devices and obtaining, as management information, at least one of a total count, an average and a rate with respect to a predetermined status of call; and
getting the management information displayed on a display device.

16. The management method according to claim 15, wherein the predetermined status of call is at least one of abort, a response, wait, a first call, a callback, a transfer, origination of a call, origination of a call, a speech when originating a call and a speech when receiving call.

17. The management method according to claim 15, wherein the rate is at least one of a response rate defined as a rate of a response call count to a total call count, an abort rate defined as a rate of an abort call count to the total call count, an originating number rate defined as a rate of a call count with an originating number notified to the call count excluding the transfer calls, a callback rate defined as a rate of a callback count to the call count with the originating number notified, a within-waiting-time-3-min ratio defined as a ratio of a response call count within 3 min waiting time to the response call count, a within-waiting-time-1-min ratio defined as a ratio of a response call count within 1 min waiting time to the response call count, and productivity defined as a rate of a recipient count to the response call count.

18. The management method according to claim 15, wherein the terminal device notifying the management device of the status information representing a status of at least one of log-in of the recipient who operates the terminal device, a quit-the-seat status, a work other than a speech and log-out; and
further comprising a step of obtaining based on the status information, as the management information, at least one of an operating rate defined as a rate of the speech time and the work time to the log-in time from the log-in up to the log-out, a reception-enabled rate defined as a rate of the reception-enabled time for which neither the speech nor the quit-the-seat status occurs to the log-in time, and a quit-the-seat rate defined as a rate of the quit-the-seat time to the log-in time.

19. The management method according to claim 15, further comprising steps of:
registering the management information in the storage unit;
reading the past management information from the storage unit and utilizing the readout information as prediction information;
notifying the display device of the prediction information together with the management information, and wherein the display device obtains the management information and the prediction information, thereby to display them on the display device.

20. A storage medium readable by a management device, tangible embodying a management program of instructions executable by the management device which connects to an exchange accommodating a plurality of terminal devices used for receiving calls, the management device to perform method steps comprising:
receiving status information showing the call receiving status of each terminal device from the exchange;
totalizing pieces of status information of the whole terminal devices and obtaining, as management information, at least one of a total count, an average and a rate with respect to a predetermined status of call; and
getting the management information displayed on a display device.
